(19) United States
(12) Patent Application Publication
(10) Pub. No.: US 2004/0036809 A1
(43) Pub. Date: Feb. 26, 2004

(54) Automatic channel selecting device

(76) Inventor: Toshikazu Taniguchi, Takefu-shi (JP)

Correspondence Address: REED SMITH LLP, Suite 1400, 3110 Fairview Park Drive, Falls Church, VA, 22042, US

(21) Appl. No.: 10/610,889

(22) Filed: Jul. 2, 2003

(30) Foreign Application Priority Data
Jul. 3, 2002 (JP) 2002-194212

(51) Int. Cl. H04N 5/50

(52) U.S. Cl. 348/731; 725/38

(57) ABSTRACT

It is an object to provide an automatic channel selecting device capable of accurately presetting a receiving frequency for a channel to be broadcast in a short time. An automatic channel selecting device used in an apparatus for receiving a broadcast wave and presetting a receiving frequency of a channel to be broadcast has the following structure. A channel selecting control microcomputer (5) sets a specific frequency to a tuner, and whether a broadcast wave for the specific frequency is received is detected by a wave detecting circuit (3), a synchronization detecting circuit (4) and the channel selecting control microcomputer (5) to carry out preset. The preset is carried out by detecting whether one channel is received at a first frequency and a second frequency and determining either of the frequencies at which the receipt is detected to be a receiving frequency of the channel. A center frequency of one channel is selected as the first frequency and a low frequency shifted by a constant frequency from the center frequency of the channel toward a low frequency side is selected as the second frequency. As the second frequency is selected a low frequency shifted toward a low frequency side by ¼ to ⅖ of a difference in a frequency between the center frequency of the channel and center frequencies of other adjacent channels present in the same band.

### BACKGROUND OF THE INVENTION

1. Field of the Invention

The present invention relates to an automatic channel selecting device for presetting a receiving frequency in an apparatus for receiving a broadcast wave.

2. Description of the Related Art

In an apparatus to be operated upon receipt of a broadcast wave of a television or the like, a frequency for receiving each channel is regulated based on the predetermined center frequency of each channel to be broadcast.

More specifically, the center frequency of each channel to be broadcast is determined by a channel plan. A channel which can be received and a frequency at which the channel can be actually received are varied depending on geographical regions. Accordingly, preset is carried out to redetermine a channel which can be received for each region and to redetermine a frequency for receiving each channel.

The preset is carried out by setting a region or by using an auto-fine tuning circuit (AFT). The preset is carried out by setting a region in the following manner. A region to be a receiving object is divided into several portions. A frequency for receiving each channel is set for each region thus divided. The preset is uniformly carried out at the frequency thus set.

In the preset using the auto-fine tuning circuit, a frequency for receiving is continuously changed over the whole range of frequencies corresponding to all channels set based on a channel plan and a frequency having tuning detected by the auto-fine tuning circuit is determined to be a receiving frequency.

In some cases, however, a preset receiving frequency is not coincident with a receivable frequency depending on the vicinity of a boundary between the divided regions and the conditions of location so that the preset based on the region setting cannot be carried out accurately.

In the preset using the auto-fine tuning circuit, moreover, a receivable frequency is to be detected over the whole range of frequencies corresponding to all channels. For this reason, a processing for carrying out the preset becomes complicated and a long time is taken for the preset.

### SUMMARY OF THE INVENTION

Therefore, it is an object of the present invention to provide an automatic channel selecting device capable of accurately presetting a receiving frequency for a channel in a short time.

In order to attain the object, the present invention provides an automatic channel selecting device used in an apparatus for selecting and receiving a broadcast wave by means of a tuner and presetting a receiving frequency of a channel based on a predetermined channel plan, comprising:

a channel selecting control microcomputer for setting a specific frequency to the tuner and detecting whether a broadcast wave for the specific frequency thus set is received, thereby carrying out the preset,

wherein the preset is carried out by detecting whether one channel based on the channel plan is received at a first frequency and/or a second frequency and determining either the first frequency or the second frequency at which the receipt is detected to be a receiving frequency of the one channel when the receipt of the one channel is detected,

the first frequency is set to be a center frequency of the one channel, and

the second frequency is set to be a low frequency shifted from the center frequency of the one channel toward a low frequency side by ¼ to ⅖ of a difference in a frequency between the center frequency of the channel and center frequencies of other adjacent channels which are present in the same band as a band of the channel.

According to the automatic channel selecting device in accordance with the present invention, the preset is carried out by detecting whether one channel is received at the first frequency and/or the second frequency. More specifically, whether one channel is received at the first and second frequencies is detected or whether one channel is received at the first or second frequency is detected.

The first frequency or the second frequency at which the receipt of one channel is detected is determined to be the receiving frequency of the one channel. On the other hand, if it is detected that one channel is received at neither the first frequency nor the second frequency, it is determined that the one channel cannot be received.

Thus, one channel is preset. Therefore, the preset can be carried out in a short time by a simple processing.

Moreover, the preset can be carried out in a place in which the automatic channel selecting device is to be provided. Therefore, the preset can be accurately carried out in all regions. Thus, the preset can be carried out precisely.

Furthermore, the second frequency can be a low frequency shifted by ⅓ of the difference in a frequency. Consequently, a channel to be a preset object can be received more accurately between adjacent channels. Thus, the preset can be carried out more accurately.

In order to determine the receiving frequency of the one channel, moreover, when a receipt at either the first frequency or the second frequency is detected, either of the frequencies can be determined to be the receiving frequency of the one channel without the detection of the receipt at the other frequency. Consequently, the preset can be carried out in a shorter time.

In the case in which the first frequency or the second frequency is determined to be the receiving frequency when the receipt for either of the frequencies is detected, furthermore, the preset is carried out in order of a channel having a low center frequency and a channel having a high center frequency and the second frequency can be determined to be the receiving frequency of the channel when a receipt at the second frequency is detected.

Consequently, when the receipt is detected at the second frequency for one channel, the receiving frequency is determined without detecting whether the receipt is carried out at the first frequency. Thus, the preset for all the channels can be carried out in a shorter time.

### BRIEF DESCRIPTION OF THE DRAWINGS

FIG. 1 is a block diagram showing an automatic channel selecting device according to the present invention,

FIG. 2 is a table showing a channel plan for a channel to be broadcast in a first broadcast mode,

FIG. 3 is a flowchart showing a processing procedure for executing a first operation example,

FIG. 4 is a table showing a channel plan for a channel to be broadcast in a second broadcast mode,

FIG. 5 is a flowchart showing a processing procedure for executing a second operation example,

FIG. 6 is a table showing an example of a channel plan to which the present invention can be applied,

FIG. 7 is a table showing an example of a channel plan to which the present invention can be applied,

FIG. 8 is a table showing an example of a channel plan to which the present invention can be applied, and

FIG. 9 is a table showing an example of a channel plan to which the present invention can be applied.

### DESCRIPTION OF THE PREFERRED EMBODIMENTS

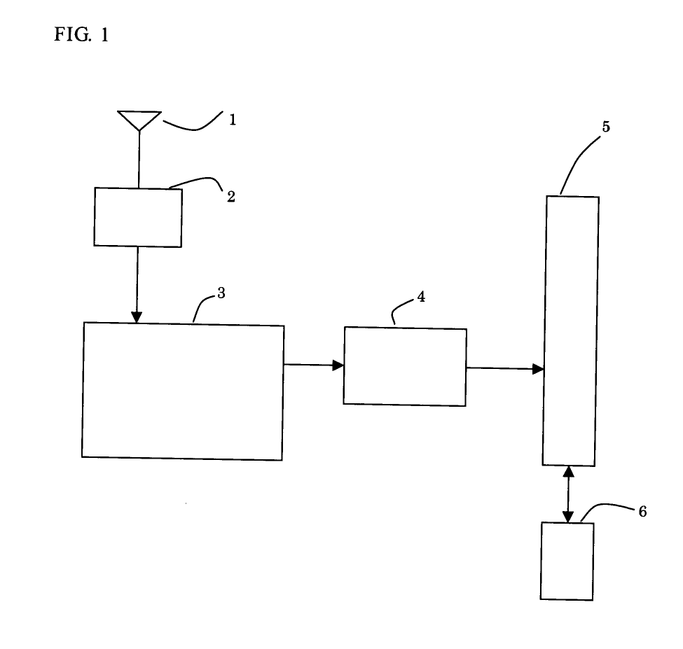

A preferred embodiment of the present invention will be described with reference to FIGS. 1 to 5. An automatic channel selecting device which will be described below can be used for an apparatus such as a television monitor for receiving the broadcast wave of a television.

FIG. 1 is a block diagram schematically showing the structure of an automatic channel selecting device according to the present invention. In FIG. 1, the automatic channel selecting device according to the present invention comprises a wave detecting circuit 3, a synchronization detecting circuit 4, a channel selecting control microcomputer 5 and a memory 6. In FIG. 1, moreover, 1 denotes an antenna and 2 denotes a tuner.

The antenna 1 receives the broadcast wave of each channel transmitted from each broadcasting station. The tuner 2 takes a signal having a specific frequency set according to the selection of a channel in the broadcast wave of each channel received by the antenna 1 and carries out a predetermined processing, and outputs the signal to the wave detecting circuit 3 which will be described below.

Moreover, a channel selecting frequency of the tuner 2, that is, a specific frequency of a broadcast wave to be received by the tuner 2 is set by the channel selecting control microcomputer 5 which will be described below.

The wave detecting circuit 3 serves to do wave detecting for a signal input from the tuner 2, and particularly includes a video wave detecting circuit, a voice detecting circuit, an AFT circuit (an auto-fine tuning circuit) and the like which are not shown. The wave detecting circuit 3 outputs inputs a video wave detecting output signal (a luminance signal, a carrier chrominance signal, a synchronizing signal and the like) and a voice wave detecting output signal when a signal is inputted from the tuner 2.

The synchronization detecting circuit 4 detects a synchronizing signal included in the video wave detecting output signal input from the wave detecting circuit 3 and outputs a synchronization detecting signal (an SD signal) when the presence of the synchronizing signal is detected. The SD signal is output from the synchronization detecting circuit 4 and is input to the channel selecting control microcomputer 5.

The channel selecting control microcomputer 5 sets a frequency of a broadcast wave to be received by the tuner 2. Moreover, the channel selecting control microcomputer 5 presets a receiving frequency for receiving each channel based on a predetermined channel plan.

The channel selecting control microcomputer 5 includes an ROM (a read only memory) and an RAM (a random-access memory) which are not shown. A channel selecting control program is stored in the ROM of the channel selecting control microcomputer 5.

The channel selecting control program can be executed by the channel selecting control microcomputer 5 and the receiving frequency for each channel can be preset. Moreover, a channel selecting frequency can be set to the tuner 2 in accordance with an instruction of the channel selecting control program.

Moreover, the channel selecting control program stores data on a channel decided to have a synchronizing signal based on the SD signal in the external memory 6 connected to the channel selecting control microcomputer 5. The memory 6 can be constituted by an E2PROM or the like.

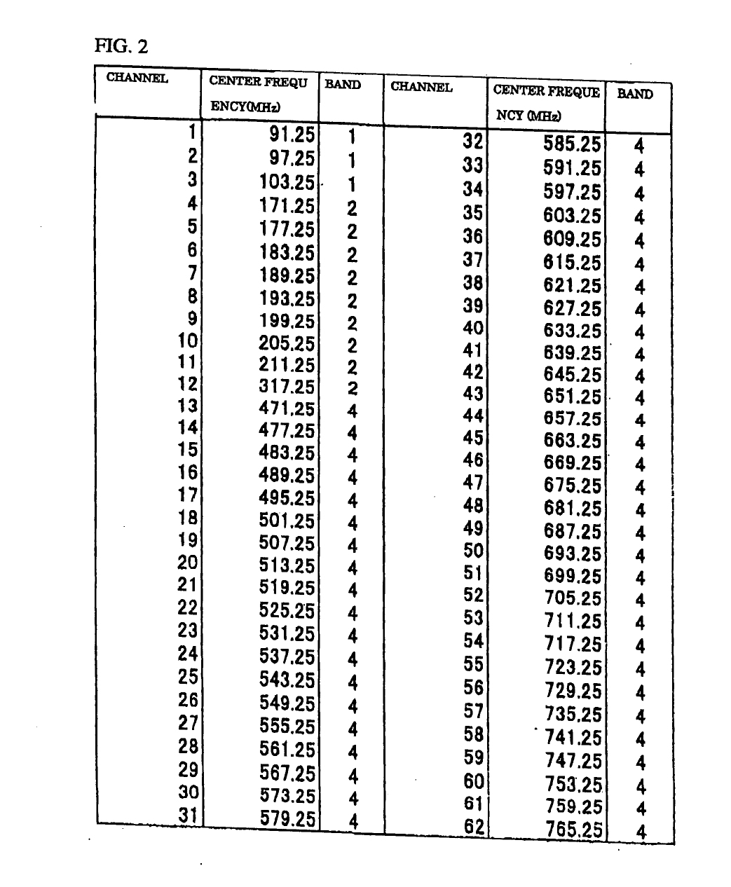

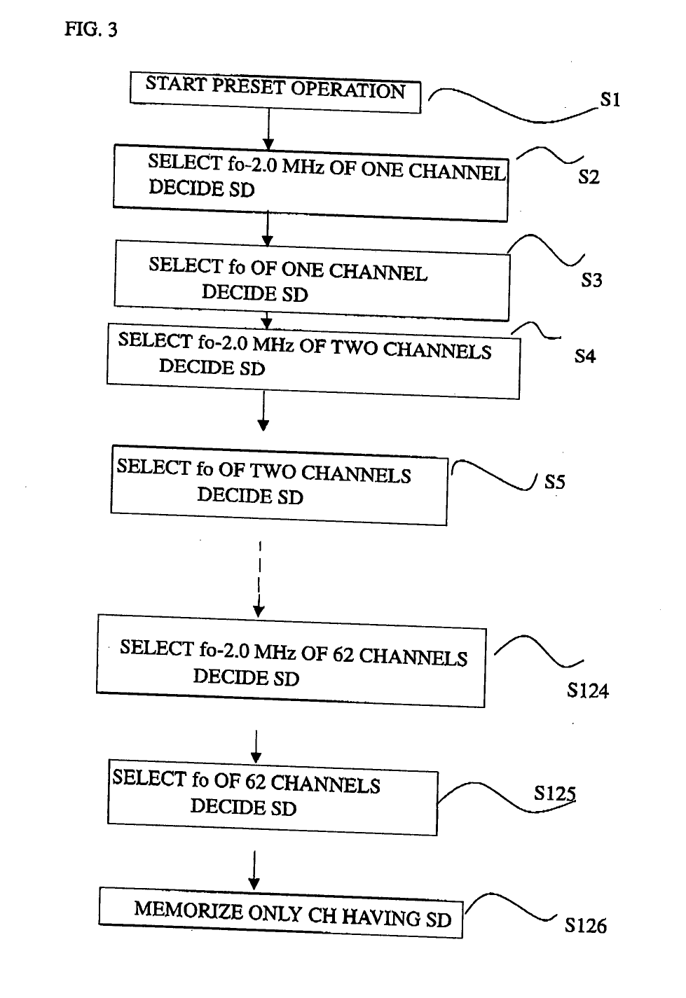

Description will be given to an example in which the automatic channel selecting device according to the present invention is operated. First of all, a first operation example will be described with reference to FIGS. 2 and 3. In the first operation example, each channel to be broadcast in a first broadcast mode is preset by the automatic channel selecting device described above.

FIG. 2 shows a channel plan for channels to be broadcast in the first broadcast mode. As shown in FIG. 2, 1 to 62 channels are prepared for the first broadcast mode. Each channel is broadcast by setting a frequency indicated corresponding to each channel to be a center frequency of a broadcast wave.

As shown in FIG. 2, moreover, 1 to 3 channels belong to a first band group, 4 to 12 channels belong to a second band group, and 13 to 62 channels belong to a fourth band group. A difference in a center frequency between the adjacent channels belonging to the same band is 6 MHz.

FIG. 3 is a flowchart showing a processing procedure for executing the first operation example, which is a part of a procedure for a channel selecting control program. When the automatic channel selecting device is operated together with the antenna 1 and the tuner 2 shown in FIG. 1, the execution of the channel selecting control program is started by the channel selecting control microcomputer 5 so that a preset operation is started (S1).

First of all, a low frequency shifted from a center frequency f0 of the 1 channel toward the low frequency side by 2 MHz is set to be a channel selecting frequency into the tuner 2 and an SD signal output from the synchronization detecting circuit 4 is decided (S2).

Next, the center frequency f0 of the 1 channel is set to be the channel selecting frequency into the tuner 2 and the SD signal output from the synchronization detecting circuit 4 is decided (S3).

Referring to each of the 2 to 62 channels, subsequently, the lower frequency than the center frequency f0 by 2 MHz is set into the tuner 2 to decide whether the SD signal is detected or not in the same manner as the procedure carried out for the 1 channel. Next, the center frequency f0 is set into the tuner 2 to decide whether the SD signal is detected or not (S4 to S125).

For a low frequency and a center frequency which are set to each of the 1 to 62 channels, then, a channel (CH) from which the SD signal is detected and a frequency thereof are stored in the memory 6 (S126).

The above procedure is executed. If the SD signal is not detected at both the low frequency and the center frequency for one channel, it is detected that the one channel cannot be received.

By the above procedure, the automatic channel selecting device for channels determined by the channel plan shown in FIG. 2 completes the preset.

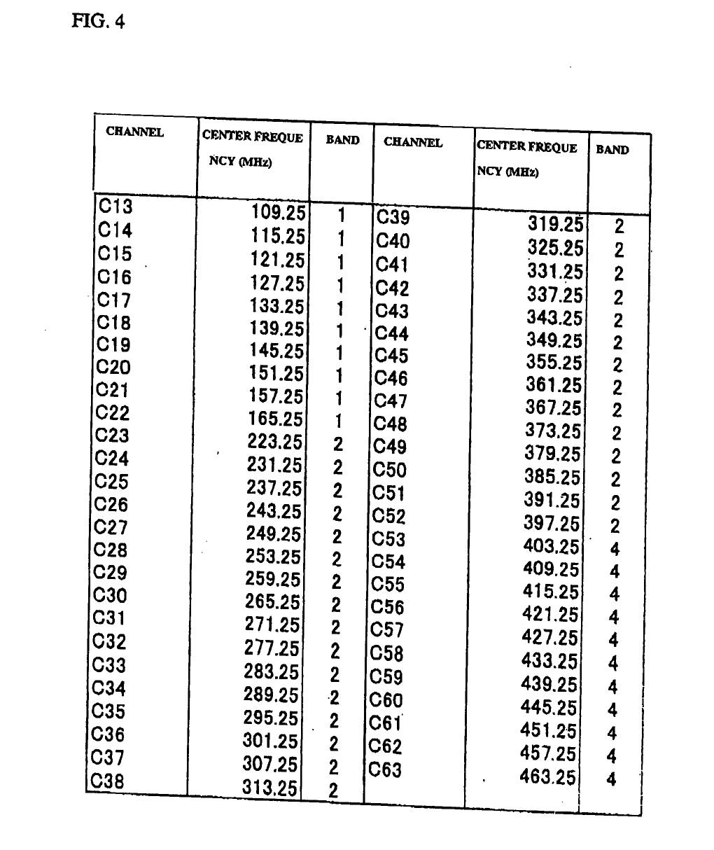

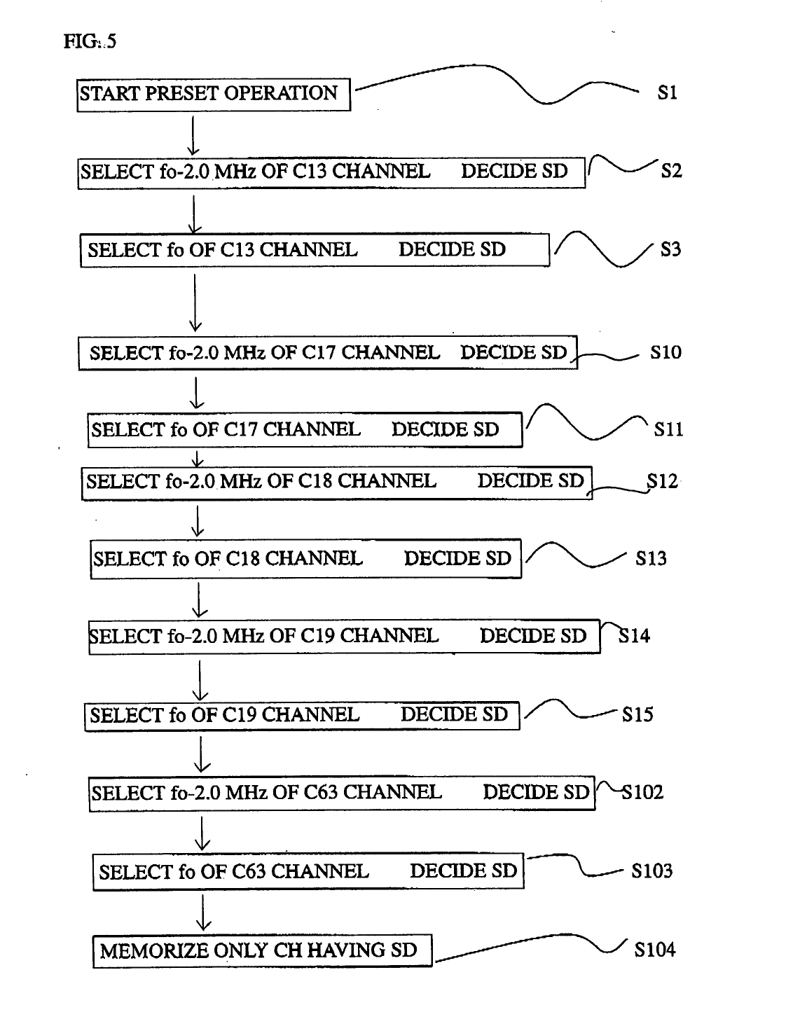

Next, a second operation example will be described with reference to FIGS. 4 and 5. In the second operation example, each channel to be broadcast in a second broadcast mode is preset by the automatic channel selecting device described above.

FIG. 4 shows a channel plan for channels to be broadcast in the second broadcast mode. As shown in FIG. 4, 51 channels, that is, C13 to C63 channels are prepared for the second broadcast mode. Each channel is broadcast by setting a frequency indicated corresponding to each channel to be a center frequency of a broadcast wave.

As shown in FIG. 4, moreover, C13 to C22 channels belong to a first band group, C23 to C52 channels belong to a second band group, and C53 to C63 channels belong to a fourth band group. A difference in a center frequency between the adjacent channels belonging to the same band is 6 MHz.

FIG. 5 is a flowchart showing a processing procedure for executing the second operation example, which is a part of a procedure for a channel selecting control program. When the automatic channel selecting device is operated together with the antenna 1 and the tuner 2 shown in FIG. 1, the execution of the channel selecting control program is started by the channel selecting control microcomputer 5 so that a preset operation is started (S1).

First of all, a low frequency shifted from a center frequency f0 of the C13 channel toward the low frequency side by 2 MHz is set to be a channel selecting frequency into the tuner 2 and an SD signal output from the synchronization detecting circuit 4 is decided (S2).

Next, the center frequency f0 of the C13 channel is set to be the channel selecting frequency into the tuner 2 and it is decided whether the SD signal is output from the synchronization detecting circuit 4 or not (S3).

Referring to each of the C14 to C63 channels, subsequently, the lower frequency than the center frequency f0 by 2 MHz is set into the tuner 2 to decide whether the SD signal is detected or not in the same manner as the procedure carried out for the C13 channel. Next, the center frequency f0 is set into the tuner 2 to decide whether the SD signal is detected or not (S10 to S103).

For a low frequency and a center frequency which are set to each of the C13 to C63 channels, then, a channel (CH) from which the SD signal is detected and a frequency thereof are stored in the memory 6 (S104).

The above procedure is executed. If the SD signal is detected at neither the low frequency nor the center frequency for one channel, it is detected that the one channel cannot be received.

By the above procedure, the automatic channel selecting device for channels determined by the channel plan shown in FIG. 4 completes the preset.

In the description of FIGS. 3 and 5, when the receipt of each channel is to be detected, the center frequency f0 of each channel is equivalent to the first frequency and the low frequency shifted from the center frequency f0 toward the low frequency side by 2.0 MHz is equivalent to the second frequency.

As described above, according to the automatic channel selecting device in accordance with the present invention, when the receipt of one channel is to be detected, whether the receipt is carried out at two frequencies including the center frequency (the first frequency) and the low frequency (the second frequency) is detected. Consequently, the preset can be carried out in a shorter time by a simple processing.

Moreover, the preset is carried out in a place in which the automatic channel selecting device is used. Therefore, the preset can be accurately carried out in every place in which the automatic channel selecting device is to be provided. Thus, the preset can be carried out precisely.

In the above description, moreover, the frequency shifted from the center frequency toward the low frequency side by 2.0 MHz is taken as a specific example of a low frequency for detecting the receipt of one channel. In the example described above, a difference in the center frequency between the adjacent channels present in the same band is 6 MHz as shown in FIGS. 2 and 4, and the low frequency shifted from the center frequency toward the low frequency side by 2 MHz which is equal to ⅓ of the difference in the frequency is selected.

As a low frequency for detecting the receipt of one channel is selected a low frequency shifted from the center frequency toward the low frequency side by ¼ to ⅖ of the difference in the center frequency between the adjacent channels present in the same band which are determined by the channel plan. By selecting the low frequency within the range for the center frequency of a channel of which receipt is to be detected, it is possible to receive the channel at either the center frequency or the low frequency within a receiving capability range required for the automatic channel selecting device.

It is the most preferable that a low frequency shifted from the center frequency toward the low frequency side by ⅓ of the difference in the center frequency between the adjacent channels should be selected as the low frequency for receiving the channel. Consequently, the receipt for a channel to be a preset object can be carried out more accurately between the adjacent channels. Thus, the preset can be carried out more precisely.

While the detection for the low frequency is carried out and the detection for the center frequency is then carried out in order to detect the receipt of one channel in the above description, it is also possible to carry out the detection for the center frequency and then the detection for the low frequency.

In the execution of the above procedure, when it is detected that the receipt is carried out at either the low frequency or the center frequency for the channel, the detection of the receipt for the other frequency can be prevented. Consequently, the preset can be carried out in a shorter time.

In particular, in the case in which the detection at the low frequency is carried out earlier as shown in FIGS. 3 and 5 in order to detect one channel, the preset can be executed in a shorter time.

More specifically, in the case in which the receipt of each channel is detected in order of a channel having a low center frequency and a channel having a high center frequency and the detection for the low frequency is carried out earlier for one channel as shown in FIGS. 3 and 5, the detection of the receipt at the center frequency is not carried out but the low frequency is determined to be the receiving frequency if the receipt at the low frequency is detected. Thus, the preset for all the channels can be carried out in a shorter time.

In the above description, moreover, the wave detecting circuit 3 and the synchronization detecting circuit 4 are provided and the channel selecting control microcomputer 5 detects the presence of the synchronizing signal based on the SD signal output from the synchronization detecting circuit 4.

In order to carry out the automatic channel selecting device according to the present invention, the detecting circuit 3 and the synchronization detecting circuit 4 do not need to be provided. More specifically, a video signal output from the tuner 2 is directly input to the channel selecting control microcomputer 5 and the presence of the synchronizing signal included in the video signal is detected so that whether the channel is received can also be detected.

While the above description has been given by taking the specific examples of the channel plan shown in FIGS. 2 and 4, moreover, the automatic channel selecting device according to the present invention can be carried out irrespective of the contents of the channel plan and can also be carried out based on channel plans other than the channel plans shown in FIGS. 2 and 4.

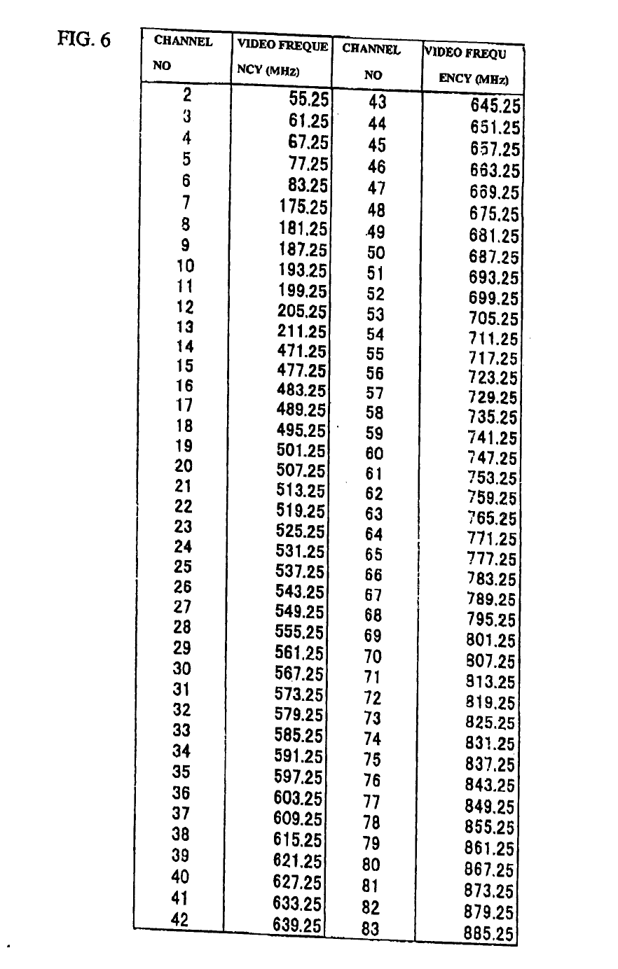

FIGS. 6 to 9 show specific examples of other channel plans in which the receiving frequency of each channel can be preset by the automatic channel selecting device according to the present invention. FIG. 6 shows a channel plan having 86 channels in total. FIG. 6 shows a channel number of each channel and a video frequency (a center frequency) of each channel.

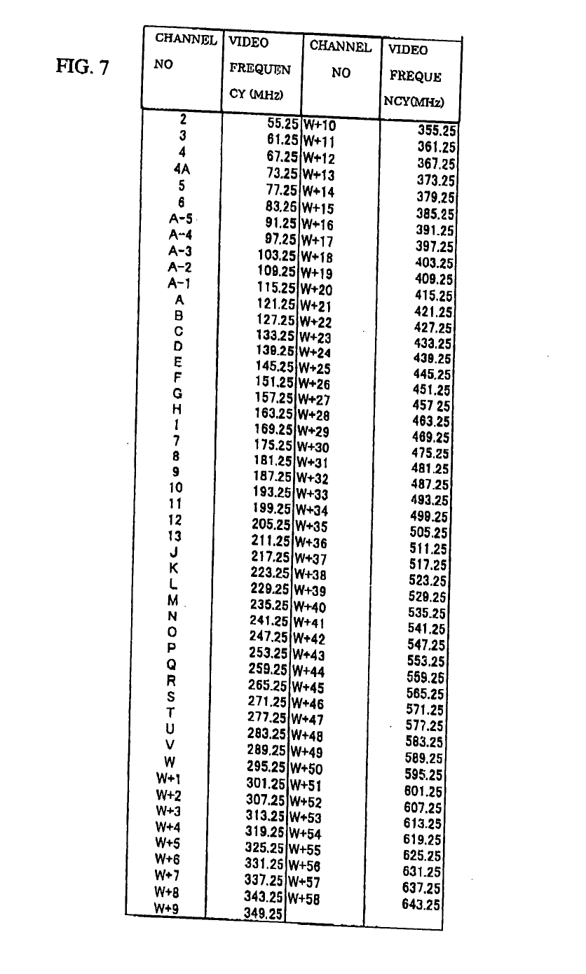

FIG. 7 shows a channel plan having 99 channels in total. FIG. 7 shows a channel number of each channel and a video frequency (a center frequency) of each channel.

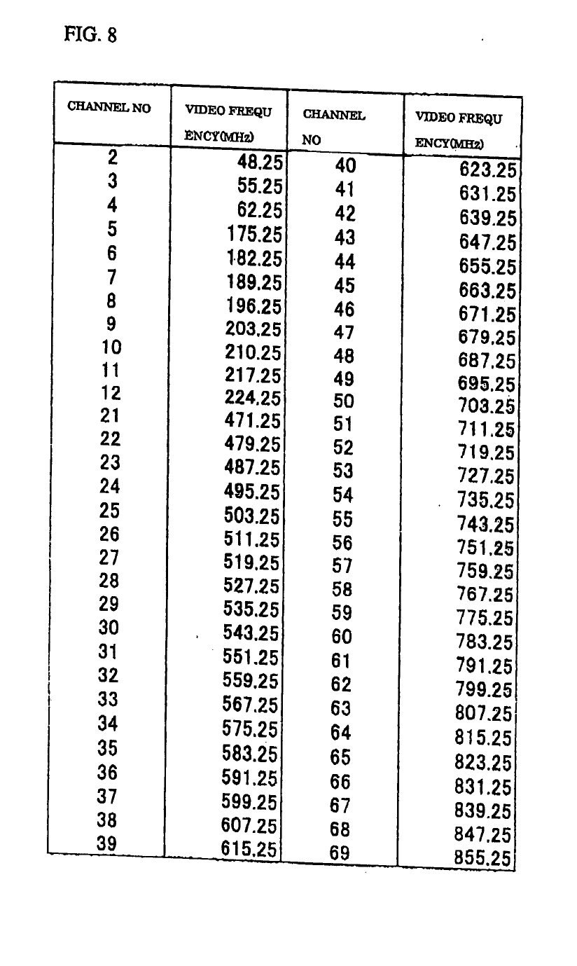

FIG. 8 shows a channel plan having 60 channels in total. FIG. 8 shows a channel number of each channel and a video frequency (a center frequency) of each channel.

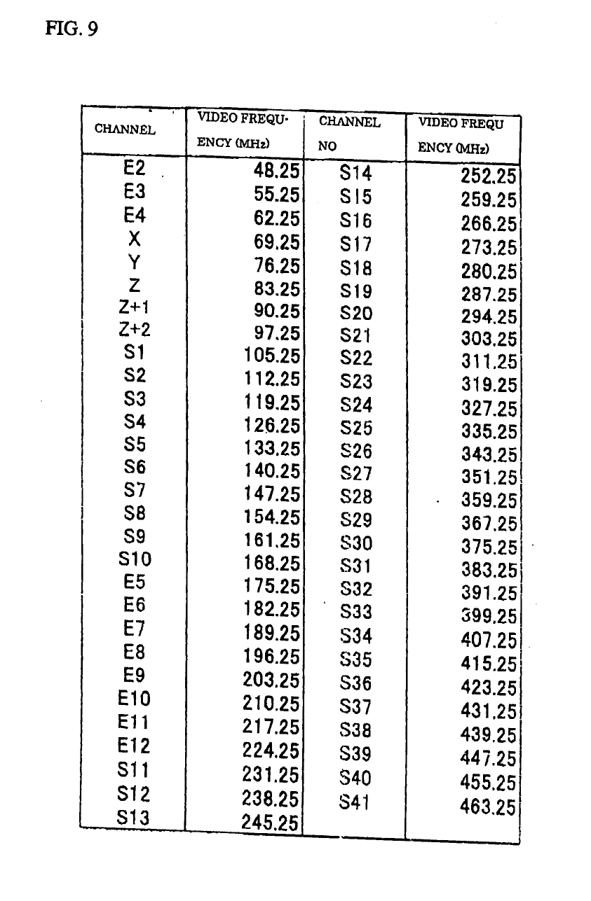

FIG. 9 shows a channel plan having 57 channels in total. FIG. 9 shows a channel number of each channel and a video frequency (a center frequency) of each channel.

According to the automatic channel selecting device in accordance with the present invention, a receiving frequency for receiving each channel can be preset for each of the channel plans shown in FIGS. 6 to 9.

As described above, according to the automatic channel selecting device in accordance with the present invention, it is possible to produce an advantage that a receiving frequency for each channel determined by a channel plan can be accurately preset in a short time by a simple processing.

What is claimed is:

1. An automatic channel selecting device used in an apparatus for selecting and receiving a broadcast wave by means of a tuner and presetting a receiving frequency of a channel based on a predetermined channel plan, comprising:
a channel selecting control microcomputer for setting a specific frequency to said tuner and detecting whether a broadcast wave for the specific frequency thus set is received, thereby carrying out the preset,
wherein said preset is carried out by detecting whether one channel based on the channel plan is received at a first frequency and/or a second frequency and determining either the first frequency or the second frequency at which the receipt is detected to be a receiving frequency of said one channel when the receipt of the channel is detected,
the first frequency is a center frequency of said one channel, and
the second frequency is a low frequency shifted from said center frequency of said one channel toward a low frequency side by ¼ to ⅖ of a difference in a frequency between said center frequency of said channel and center frequencies of other adjacent channels which are present in the same band as a band of said one channel.

2. The automatic channel selecting device according to claim 1, wherein said second frequency is a low frequency shifted by ⅓ of said difference in a frequency.

3. The automatic channel selecting device according to claim 1 or 2, wherein when a receipt at either said first frequency or said second frequency is detected, either of the frequencies is determined to be the receiving frequency of said one channel without the detection of the receipt at the other frequency.

4. The automatic channel selecting device according to claim 3, wherein said preset is carried out in order of a channel having a low center frequency and a channel having a high center frequency and said second frequency is determined to be the receiving frequency of said one channel when a receipt at the second frequency is detected.
